(19) United States
(12) Patent Application Publication
(10) Pub. No.: US 2021/0258154 A1
(43) Pub. Date: Aug. 19, 2021

(54) NODE GROUP MANAGING DEVICE AND COMPUTING DEVICE FOR CONFIGURING GROUP KEY-BASED DUAL SIGNATURE TRANSACTION STRUCTURE IN BLOCKCHAIN NETWORK

(71) Applicant: Ki Eob PARK, Gyeonggi-do (KR)

(72) Inventors: Ki Eob PARK, Gyeonggi-do (KR); Young Uk SON, Gyeonggi-do (KR); Hyun Chel DO, Gyeonggi-do (KR); Mi Ra JUNG, Gyeonggi-do (KR); Kwang Eun CHAE, Gyeonggi-do (KR); Byoung Ryul JEON, Gyeonggi-do (KR); Ju Won YOON, Gyeonggi-do (KR)

(73) Assignee: Ki Eob PARK, Gyeonggi-do (KR)

(21) Appl. No.: 17/159,021

(22) Filed: Jan. 26, 2021

Related U.S. Application Data
(63) Continuation of application No. PCT/KR2019/001731, filed on Feb. 13, 2019.
(60) Provisional application No. 62/703,896, filed on Jul. 27, 2018.

(30) Foreign Application Priority Data
Feb. 7, 2019 (KR) 10-2019-0014619

(51) Int. Cl. H04L 9/08; H04L 9/06; H04L 9/32

(52) U.S. Cl. CPC H04L 9/0833; H04L 9/0825; H04L 9/0872; H04L 2209/38; H04L 9/088; H04L 9/0894; H04L 9/3247; H04L 9/0643

(57) ABSTRACT

A node group management device includes a communication interface managing a first group, to which some nodes belong among nodes that constitute a blockchain network sharing a distributed database, a memory that stores information related to a node of the first group (including a public key of each node of the first group), and a processor connected to the memory. All nodes participating in the blockchain network each include a private key and a public key. The processor operates according to instructions stored in the memory and generates a group private key allowing a transaction to be additionally signed based on said information while the transaction is signed with the private key when the node of the first group generates the transaction and configured to distribute the group private key to the first group so that the nodes of the first group hold the group private key in common.

### CROSS-REFERENCE TO RELATED APPLICATIONS AND PRIORITY

This application is a continuation of PCT/KR2019/001731, filed Feb. 13, 2019, which claims priority to and the benefit of Korean Patent Application No. 10-2019-0014619, filed on Feb. 7, 2019, and U.S. Provisional Application No. 62/703,896, filed Jul. 27, 2018, the disclosures of which are incorporated herein by reference in their entirety.

### FIELD

Embodiments of the present disclosure relate to a technique for enhancing security by constructing a transaction structure that requires a dual signature and verification based on a group key on a blockchain network.

### BACKGROUND

A blockchain system operates a blockchain in which blocks containing information are connected in a chain form as a distributed database to allow nodes constituting a blockchain network to share common information. In order to record or change information in such a blockchain, a node generates a transaction on the network and undergoes a process of other nodes verifying whether the transaction is correct. The generation and verification of such a transaction are performed with a private key and a public key held by each node.

Each node exposes only its own public key to the blockchain network, signs information to be delivered with its own private key, and propagates a transaction that binds the information to be transmitted and the signature to other nodes. A node that receives the transaction performs a verification process on the transaction by decrypting the signature with the public key and checking whether the transaction has been signed by the correct person.

Since a public key is generated based on a private key but is generated through an irreversible function, it is difficult to recover the private key from the public key even if the public key is known. However, if the private key itself is hacked, there is a fatal problem in that the hacker can generate all desired transactions in the corresponding account. For this reason, if the hacker creates a malicious transaction that transfers all cryptocurrencies held in the account to another place and records the transaction in a block, this cannot be undone again on the blockchain, which leads to very serious damage.

However, since a private key cannot be changed once it has been determined, it is necessary to change an account immediately with only one leak, and there are many cases in which serious damage that cannot be reversed has already occurred even before it is known that the private key is leaked.

As described above, a blockchain account that is protected with only one private key has a fatal weakness in that the private key itself may be hacked, so there is a need for a new alternative to more effectively protect the account.

### SUMMARY

Embodiments of the present disclosure are intended to solve the above problems through a technique of generating a group private key shared between only a plurality of nodes in a group on the basis of information on the group composed of the nodes. A group private key generated at this time may be generated by a node with secured reliability that manages information on nodes in a group. The nodes of the group which share benefits such as security enhancement due to the group private key have no practical advantage in leaking the group private key, and nodes outside the group cannot know information on the other groups, and thus it may be designed such that the group private key cannot be inferred.

Also, embodiments of the present disclosure can prevent hacking damage from occurring even if a group private key is leaked by utilizing a technique that updates a group private key periodically or when a change occurs in a node group. In addition, when a hacker attempts to generate a malicious transaction, a signature is additionally required through another key, so it is possible for an account holder to have time to prepare alternatives after becoming aware of hacking.

As described above, the embodiments of this document are intended to improve the security of the blockchain network by constructing a structure requiring dual transaction signature and verification.

According to an embodiment, a node group management device that manages a first group to which some nodes belong among nodes that constitute a blockchain network sharing a distributed database, wherein all nodes participating in the blockchain network each include a private key and a public key, may include a communication interface configured to communicate with the blockchain network; one or more memories configured to store information related to a node of the first group and instructions related to processor operations, wherein the information related to the node of the first group includes a public key of each node of the first group; and one or more processors connected to the one or more memories to operate according to the instructions and configured to generate a group private key that allows a transaction to be additionally signed based on the information related to the node of the first group while the transaction is signed with the private key when the node of the first group generates the transaction and configured to distribute the group private key to the first group so that the nodes of the first group hold the group private key in common.

According to an embodiment, a computing device that performs nodes constituting a blockchain network sharing a distributed database, wherein all nodes participating in the blockchain network each include a private key and a public key, may include a communication interface configured to communicate with the blockchain network; one or more memories configured to store information related to a node group device that manages a first group to which one of the nodes belongs, a plurality of group private keys distributed by the node group device over time, and instructions related to processor operations, wherein the plurality of group private keys include time information; and one or more processors connected to the one or more memories to operate according to the instructions and configured to add, to a transaction, a signature with a group private key generated a predetermined period before a group private key is most recently stored among the plurality of group private keys with reference to the time information when the transaction is generated.

According to an embodiment, a node group management method performed by a node group management device and nodes that constitute a blockchain network sharing a distributed database, wherein all the nodes of the blockchain network each hold a private key and a public key, may include receiving, by the node group management device, information related to a node of a first group from the node of the first group, wherein the first group is a group including nodes managed by the device, and the information related to the node of the first group includes a public key of the node of the first group; generating, by the node group management device, a group private key used to additionally sign a transaction along with the private key on the basis of the information related to the node of the first group when the node of the first group generates the transaction, and distributing, by the node group management device, the group private key to the nodes of the first group so that the nodes of the first group hold the group private key in common.

According to the above-described embodiments, a private key and a group private key are used together to sign a transaction. Thus, it is possible to prevent damage due to hacking by utilizing a construction that requests the signature with the group private key even if the private key is hacked.

Also, by generating and distributing a group private key and a group public key through a gateway with secured reliability, it is possible to increase the reliability of a group key-based transaction signature.

In addition, by generating a group private key periodically or whenever a change occurs in a node group, it is possible to minimize the possibility of exposing the group private key.

Also, by signing a transaction with a group private key distributed to all nodes in the blockchain network when a node generates the transaction, it is possible to prevent transaction verification errors due to a distribution delay.

In addition, it is possible to provide various advantageous effects that are directly or indirectly obtained through this document.

### DRAWINGS

FIG. 1 is a block diagram of a distributed network system according to an embodiment.

FIGS. 2A and 2B are diagrams illustrating a blockchain structure according to an embodiment, wherein FIG. 2A is a diagram illustrating a blockchain structure includes a plurality of blocks that are linearly connected, and FIG. 2B is a diagram of a block.

FIG. 3 is a diagram illustrating the types of nodes included in a distributed network system according to an embodiment.

FIG. 4 is a block diagram showing a full node according to an embodiment.

FIG. 5 is a block diagram showing a light node according to an embodiment.

FIG. 6 is a block diagram showing a server according to an embodiment.

FIG. 7 is a flowchart illustrating a registration process of a gateway according to an embodiment.

FIG. 8 is a flowchart illustrating a management operation of a gateway according to an embodiment.

FIGS. 9A, 9B, and 9C are flowcharts illustrating an operation of a node joining a group according to an embodiment, wherein FIG. 9A illustrates a light node communicates with gateways, FIG. 9B illustrates a light node communicates with a server, and FIG. 9C illustrates a light node communicates with a server to provide information on a gateway to be accessed.

FIG. 10 is a flowchart illustrating an operation of synchronizing a gateway list between servers according to an embodiment.

FIG. 11 is an exemplary diagram of an operation of a gateway generating a group private key according to an embodiment.

FIG. 12 is a flowchart illustrating an operation of a gateway generating and distributing a group private key and a group public key according to an embodiment.

FIG. 13 is a flowchart illustrating a situation in which a node can perform verification and a situation in which a node cannot perform verification depending on a selection of a group private key according to an embodiment.

FIG. 14 is an example diagram showing states of group public keys distributed to groups according to an embodiment.

FIG. 15 is a conceptual view of a dual signature for a transaction based on a group private key and dual verification for a transaction based on a group public key according to an embodiment.

In describing the drawings, the same or similar reference numerals may be used for the same or similar elements.

### DETAILED DESCRIPTION

Hereinafter, various embodiments will be described with reference to the accompanying drawings. It should be understood, however, that there is no intent to limit the invention to the particular forms disclosed, but on the contrary, the invention is to cover various modifications, equivalents, and/or alternatives of the embodiments.

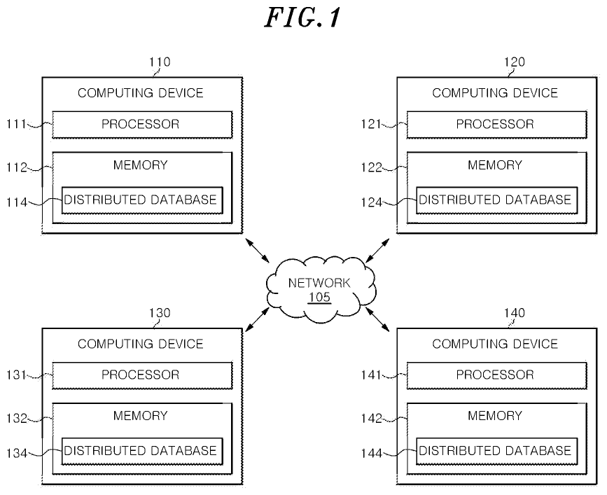

FIG. 1 is a block diagram of a distributed network system 100 according to an embodiment.

Referring to FIG. 1, the distributed network system 100 according to an embodiment may be implemented through a plurality of computing devices 110, 120, 130, and 140. Although four computing devices 110, 120, 130, and 140 are shown in FIG. 1, the present invention is not limited thereto, and the distributed network system 100 may further include any number of computing devices not shown.

The network 105 may include a wired network and/or a wireless network. For example, the network 105 may be at least one of a local area network (LAN), a wide area network (WAN), a virtual network, and a remote communication network.

In the distributed network system 100, the computing devices 110, 120, 130, and 140 may be operably connected to each other through the network 105 to constitute a blockchain network, which is a peer-to-peer (P2P) network that shares a distributed database having the same information.

The computing devices 110, 120, 130, and 140 may generate a transaction, which is a unit of work to be performed to change the state of the distributed database, on the distributed network system 100. The computing devices 110, 120, 130, and 140 may verify and execute a transaction that occurs in the distributed network system 100, store the record of the transaction in the form of a blockchain structure, and manage the distributed database.

Each of the computing devices 110, 120, 130, and 140 may generate a transaction and have blockchain account information to verify the integrity of the transaction. The blockchain account information may include a private key and a public key (hereinafter also collectively referred to as a personal key). A private key, which is a digital signature means for verifying that a transaction has been generated by a correct person, may be generated by hashing a private key and a message to be included in the transaction.

A public key may function as a user's account address or a means for verifying that a digital signature included in a transaction is generated by a correct user's private key.

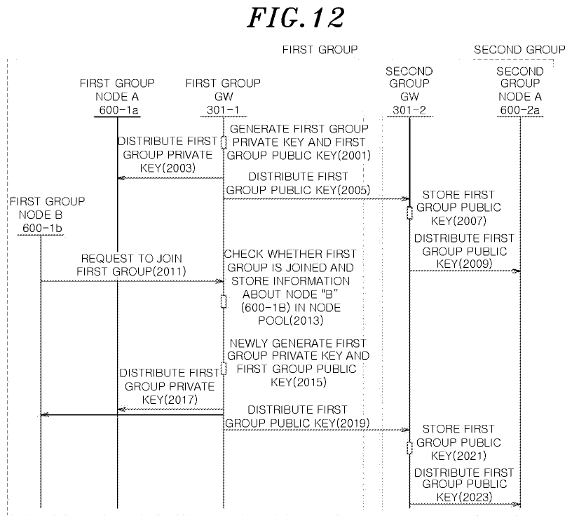

According to an embodiment of the present disclosure, the computing devices 110, 120, 130, and 140 may have a group private key and a group public key (hereinafter also collectively referred to a “group key”) which are used for a dual signature and verification for a transaction in addition to the personal key. The group key will be described in detail below with reference to FIGS. 11 to 15.

When a transaction occurs, one of the computing devices 110, 120, 130, and 140 verifies the integrity of the transaction and generates a new block following a pre-generated block on the basis of a consensus algorithm (e.g., Proof of Work (POW), Proof of Stake (POS), Delegated Proof of Stake (DPOS), etc.) promised in the distributed network system 100. The generated new block is propagated to the other computing devices 110, 120, 130, and 140 so that the transaction can be executed. The block may include a plurality of pieces of transaction information.

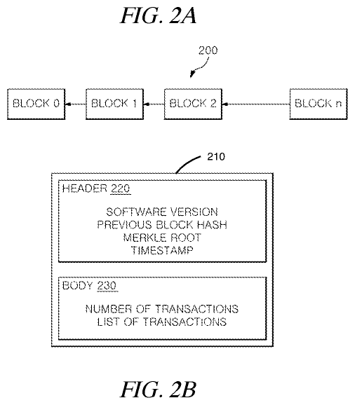

FIGS. 2A and 2B are diagrams illustrating a blockchain structure according to an embodiment.

Referring to FIG. 2A, a blockchain may be formed by pieces of data being stored in units of a block and linearly connected to one another. Each block may be connected by pointing to its preceding block (e.g., the preceding block to “block 2” being “block 1”). However, the block connection type is not limited to this example.

Referring to FIG. 2B, a block 210 may be composed of a header 220 and a body 230.

Data stored in the header 220 will be understood as summary information about the corresponding block 210. The header 220 may include a software version, which is software version information, a previous block hash, which serves as a hash pointer pointing to the previous block as a hash value of the header of the previous block, a Merkle root, which is information about summarized transactions, and a time stamp, which include a date and time at which the block 210 is generated. A block hash value may be computed based on the data stored in the header 220 of the block 210. A succeeding block can point to a preceding block by storing a block hash value of the preceding block. Accordingly, the distributed network system 100 may be referred to as a blockchain network system.

The body 230 may include a transaction list which includes transactions, which are pieces of data to be stored and preserved in the block 210, and a transaction number which is the total number of transactions included in the block 210. For example, the transaction may indicate a transaction history, but this is just an example. The present invention is not limited thereto.

The computing device 110 may include a processor 111 and a memory 112. For example, the memory 112 may include a random access memory (RAM), a memory buffer, a hard drive, a database, an erasable programmable read-only memory (EPROM), an electrically erasable programmable read-only memory (EEPROM), a read-only memory (ROM), and the like.

The processor 111 may be a general-purpose processor, a field-programmable gate array (FPGA), an application-specific integrated circuit (ASIC), a digital signal processor (DSP), and the like.

One or more parts of the computing devices 110, 120, 130, and 140 may include a hardware-based module (e.g., a DSP and an FPGA) and/or a software-based module (e.g., a module of computer code stored in a memory and/or executed by a processor). In some embodiments, one or more functions (e.g., functions associated with processors 111, 121, 131, and 141) associated with the computing devices 110, 120, 130, and 140 may be included in one or more modules.

A memory 112 of the computing device 110 may include a distributed database 114. The computing devices 110, 120, 130, and 140 may implement distributed databases 114, 124, 134, and 144 through a network 105. The distributed databases 114, 124, 134, and 144 may be understood as a public ledger in which the plurality of computing devices 110, 120, 130, and 140 share the same information. The processor 111 may be configured to execute a module, a function, and/or a process to update the distributed database 114 in response to receiving synchronization data or the like associated with a transaction (e.g., a message to change data of a distributed database) from another processor.

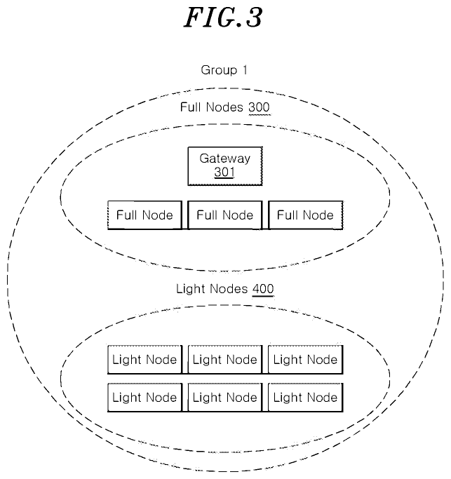

FIG. 3 is a diagram illustrating the types of nodes included in the distributed network system 100 according to an embodiment.

Referring to FIG. 3, each computing device (e.g., the computing devices 110, 120, 130, and 140 of FIG. 1) included in the distributed network system 100 may be understood as a node. The nodes included in the distributed network system 100 may be classified into a full node 300 and a light node 400.

The full node 300 is a node that synchronizes and maintains all information (e.g., header 220 information and body 230 information) included in a blockchain 200 in real time. The light node 400 is a node that is capable of performing a transaction function (e.g., a wallet function). The light node 400 may generate a transaction and propagate the generated transaction to neighboring nodes through the network 105. In some embodiments, the light node 400 may verify the generated block with only some information (e.g., header 220 information) included in the blockchain 200.

Hereinafter, the full node 300 and the light node 400 may be collectively referred to as a node 600 included in the distributed network system 100.

The nodes included in the distributed network system 100 may belong to different groups or the same group on the basis of location information. Nodes located close to each other may be classified as the same group.

The group may be determined by at least one server 500 (see FIG. 6) communicating with the distributed network system 100. The following description will assume one server 500, but a plurality of servers 500 may perform group classification. The server 500 may classify adjacent nodes as the same group on the basis of location information of the nodes. Accordingly, neighboring nodes that frequently communicate with each other belong to one group, and thus it is possible to increase communication efficiency. The server 500 may be operated by a third party.

At least a portion of the full node 300 may operate as a gateway (or GW) 301 (hereinafter also referred to as a node group management device in a portion of the disclosure). The gateway 301 may generate a block 210 and manage one group. The gateway 301 may receive a block reward by generating the block 210 and may distribute the received block reward to nodes of a group to which the gateway 301 belongs. Different gateways 301 may manage different groups. The gateway 301 may generate a group private key and a group public key, share the group private key with the nodes in the same group, and distribute the group public key to the outside of the group.

In FIG. 3, group 1 includes four full nodes 300 and six light nodes 400. One of the four full nodes 300 may operate as a gateway 301. The gateway 301 may have information regarding nodes belonging to group 1. When a block reward is received, the gateway 301 may distribute the block reward to the nodes belonging to group 1. The distributed network system 100 may have one or more groups, and each group may have at least one gateway 301.

The group configuration of each group including group 1 and the number of nodes in each group are just examples, the number of full nodes 300 except for one full node operable as the gateway 301 and the number of light nodes 400 may be randomly determined. According to an embodiment, the total number of nodes included in one group may be a maximum of 512, but this is just an example. The present invention is not limited thereto.

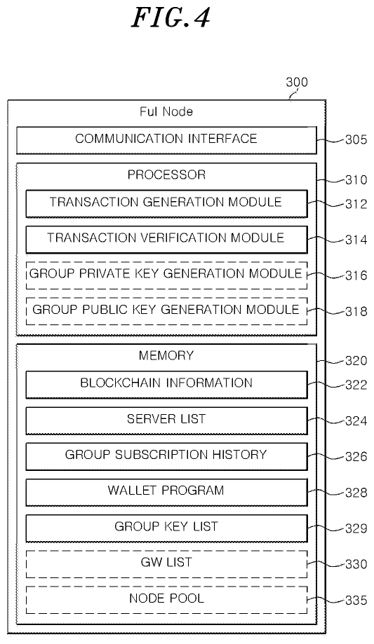

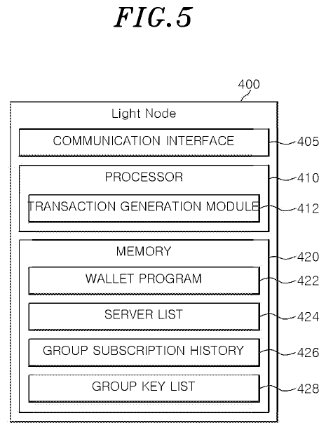

FIG. 4 is a block diagram showing a full node 300 according to an embodiment.

Referring to FIG. 4, the full node 300 may include a communication interface 305, a processor 310, and a memory 320. The full node 300 may perform communication with the server 500 and nodes included in a distributed network system 100 through the communication interface 305.

The processor 310 may include a transaction generation module 312 and a transaction verification module 314.

Also, when the full node 300 operates as the gateway 301, the processor 310 may further include a group private key generation module 316 and a group public key generation module 318.

The processor 310 may execute instructions stored in the memory 320 to drive at least one of the transaction generation module 312, the transaction verification module 314, the group private key generation module 316, and the group public key generation module 318. The transaction generation module 312, the transaction verification module 314, the group private key generation module 316, and the group public key generation module 318 may be driven when instructions included in a wallet program 328 are executed, but the present invention is not limited thereto.

The transaction generation module 312, the transaction verification module 314, the group private key generation module 316, and the group public key generation module 318 may be implemented in hardware, software, or a combination thereof. Operations performed by the transaction generation module 312, the transaction verification module 314, the group private key generation module 316, and the group public key generation module 318 may be understood as operations performed by the processor 310.

The transaction generation module 312 may generate a transaction requesting that data (e.g., a transaction history) to be stored and preserved in a block be included in the block. The transaction generation module 312 may include an electronic signature using a private key and a digital signature using a group key in the transaction.

The transaction verification module 314 may verify a self-generated transaction or a transaction received from another node on the basis of the personal public key and the group public key.

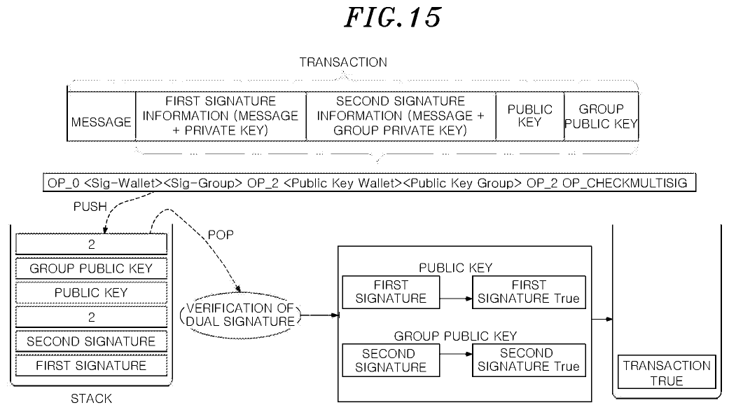

The verification of the transaction of the digital signature using the private key and the group key will be described in detail with reference to FIGS. 14 and 15.

The group private key generation module 316 may generate a group private key on the basis of information of nodes included in a group managed by the full node 300, which is the gateway 301. The group private key, which is information shared between nodes in the same group, may be used for the signature of the transaction together with the private key.

The group public key generation module 318 may generate a group public key by performing a computation on the generated group private key. The group public key, which is information distributed to a blockchain network outside the group, may be used to verify the transaction signature.

The memory 320 may include blockchain information 322 (e.g., information associated with the blockchain 200 of FIG. 2A), a server list 324, a group subscription history 326, a wallet program 328, and a group key list 329.

The blockchain information 322 may include information included in the blockchain 200 of FIG. 2A. The full node 300 according to various embodiments disclosed herein may be a computing device in a Windows or Linux environment. The full node 300 may have hardware resources capable of storing and synchronizing information related to the blockchain 200 in real time.

The server list 324 may include information associated with servers that perform grouping on the nodes of the distributed network system 100. For example, the server list 324 may include a unique ID of the server 500 and location information (Internet Protocol (IP), latitude, and longitude) of the server 500. The full node 300 may send a request to at least one server 500 included in the server list 324 to join a group or become a gateway 301.

When the full node 300 has previously joined the group, the group subscription history 326 may include information associated with the group. For example, the group subscription history 326 may include account information of the gateway 301 of the group that the full node 300 has joined.

The wallet program 328 may include data related to instructions for generating and verifying transactions. According to an embodiment, when the full node 300 operates as the gateway 301, the wallet program 328 may include data related to instructions for generating a group private key and a group public key. The account of the full node 300 may be a node address of the wallet program 328. The wallet program 328 may be a program operating in a Windows or Linux environment.

The group key list 329 may store the group private key of the group to which the full node 300 belongs and the group public key generated by an external group in addition to the group to which the full node 300 belongs. The full node 300 may store information on groups in which group private keys and group public keys are generated, information on the order in which the group private keys are generated, and information on the order in which the group public keys are generated. This will be described in detail below with reference to FIGS. 11 to 15.

When the full node 300 operates as the gateway 301, the full node 300 may further include a gateway list 330 and a node pool 335. The gateway list 330 may include information associated with gateways 301-1, 301-2, . . . , 301-n which currently operate as gateways 301 and which operate groups. The gateway list 330 may also be stored in the server 500 and may serve as a backup in an exceptional situation such as an inoperable situation of the server 500.

In various embodiments, one full node 300 may operate as a plurality of gateways. In this case, the plurality of gateways have the same IP and different port numbers.

The node pool 335 may include information associated with nodes (computing devices) belonging to the group operated by the gateway 301. The node pool 335 may include a list of nodes 600 belonging to its own group. For example, the node pool 335 may include a public key of the node 600 belonging to its own group and index information for identifying each node 600, and the index information and the public key may be mapped and stored.

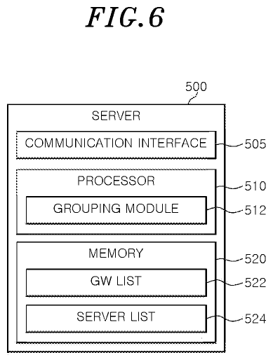

FIG. 5 shows a block diagram of a light node 400 according to an embodiment. Referring to FIG. 5, the light node 400 may include a communication interface 405, a processor 410, and a memory 420. The light node 400 may perform communication with a server 500 and nodes included in a distributed network system 100 through the communication interface 405.

A processor 510 may include a transaction generation module 412. For example, the processor 510 may execute instructions stored in a memory 520 to drive the transaction generation module 412. When instructions included in a wallet program 422 are executed, the transaction generation module 412 may be driven, but the present invention is not limited thereto.

The transaction generation module 412 may be implemented in software, hardware, or a combination thereof. An operation performed by the transaction generation module 412 may be understood as an operation performed by the processor 410.

The transaction generation module 412 may generate a transaction requesting that data (e.g., a transaction history) to be stored and preserved in a block be included in the block. The transaction generation module 412 may include an electronic signature using a private key and an electronic signature using a group key in the transaction. The transaction generation module 412 may select a group private key to be used for the signature of the transaction in consideration of information on the order in which group keys are generated. This will be described in detail below with reference to FIGS. 14 and 15.

The light node 400 may store a wallet program 222, a server list 424, and a group subscription history 426 in the memory 420.

The wallet program 422 may include data related to instructions for generating and verifying transactions. The wallet program 422 may be a program operating in a mobile environment such as Android or iOS. The server list 424 and the group subscription history 426 may be substantially the same as the server list 324 and the group subscription history 326 of the full node 300.

A group key list 428 may store a group private key of a group to which the light node 400 belongs. Here, the group key list 428 does not include a group public key for each group unlike the group key list 329 of the full node 300. This is because the light node 400 does not perform verification on transactions.

FIG. 6 is a block diagram showing the server 500 according to an embodiment. Referring to FIG. 6, the server 500 may include a communication interface 505, a processor 510, and a memory 520. The server 500 may perform communication with the nodes (the full node 300 and the light node 400) of the distributed network system 100 through the communication interface 505.

The processor 510 may include a grouping module 512. For example, the processor 510 may execute instructions stored in the memory 520 to drive the grouping module 512. The grouping module 512 may be implemented in software, hardware, or a combination thereof. An operation performed by the grouping module 512 may be understood as an operation performed by the processor 510. The grouping module 512 may determine groups for nodes on the basis of location information of the nodes.

The memory 520 may store a gateway list 522 and a server list 524. The gateway list 522 may be synchronized with the gateway list 330 stored in the full node 300. The server list 524 may include information on other servers performing the same role as the server 500.

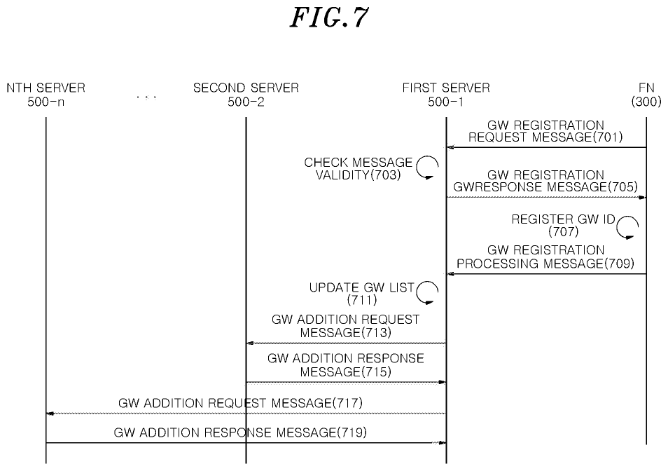

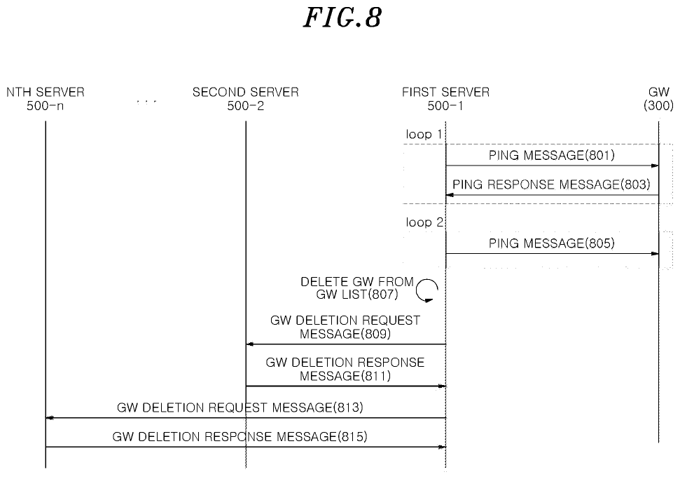

FIG. 7 is a flowchart illustrating a registration process of a gateway according to an embodiment.

To operate as a gateway 301, a full node 300 may transmit a gateway registration request message to any server (a first server 500-1) (701). The full node 300 may use a server list stored therein to transmit the message to one server included in the server list. For example, an example in which the message is transmitted to the first server 500-1 is shown.

A gateway registration message may include at least one of IP address information of the full node 300, port number information of the full node 300, latitude information of the full node 300, and longitude information of the full node 300. The pieces of information may be understood as information associated with a location of the gateway 301.

The first server 500-1 may check the validity of the received gateway registration message (703) and may transmit a gateway registration response message to the full node 300 (705). The first server 500-1 may compare gateway list information and data included in the gate registration request message. The first server 500-1 may select a gateway 301 adjacent to the full node 300 from the gateway list using information associated with a location of the full node 300.

The gateway registration response message may include a success or failure response (return_val) as the result of processing the gateway registration message and may include a gateway ID to be allocated to the full node 300.

When the processing result included in the gateway registration response message is successful, the full node 300 may register a received gateway ID as its own ID (707) and transmit a gateway registration processing message to the first server 500-1 (709). The gateway registration processing message may include a gateway ID registered by the full node 300. When the processing result included in the gateway registration response message fails, the full node 300 performs operations 701 to 709 for another server included in the server list.

When the gateway registration processing message is received, the first server 500-1 may update the gateway list with the gateway ID included in the gateway registration processing message. The first server 500-1 may propagate the updated gateway list by transmitting a gateway addition request message to other servers. The gateway addition request message may include at least one of the following pieces of information. The gateway addition request message may include a synchronization index (number) of the first server 500-1. The synchronization index may be a number that is updated when the gateway list is updated (i.e., when the gateway is added). For example, the synchronization index may be a number that ranges from 0 to pow(2,32)−1. The gateway addition request message may include the number of gateways registered in the first server 500-1 and the gateway list included in the first server 500-1. The gateway addition request message may include at least one of an IP address, a port number, latitude information, and longitude information of a gateway included in the gateway list.

For example, the gateway addition request message may be transmitted to second to nth servers 500-2 to 500-n included in the server list stored in the first server 500-1 (713 and 717). When the gateway addition request message is received, the second server 500-2 may identify the first server 500-1 which has transmitted the message. For example, the second server 500-2 may identify the first server 500-1 using an IP of a source from which the message is transmitted. The second server 500-2 may load the gateway list stored in the second server 500-2. In detail, the second server 500-2 may compare a first synchronization index included in the received message and a second synchronization index stored in the second server 500-2. When the first synchronization index is greater than the second synchronization index, the second server 500-2 may update the gateway list stored in the second server 500-2 to the gateway list received through the message and may update its own second synchronization index. When the gateway update process is completed, the second server 500-2 may transmit a gateway addition response message reflecting the processing result to the first server 500-1 (715). Operations 713 and 715 may be performed for the third to nth servers 500-3 to 500-n included in the server list of the first server 500-1 in addition to the second server 500-2.

FIG. 8 is a flowchart illustrating a management operation of a gateway according to an embodiment.

When the full node 300 is registered as the gateway 301 by the first server 500-1, the first server 500-1 is responsible for the gateway 301. Also, the full node 300 may operate as the gateway 301. The first server 500-1 may periodically check whether a message is reachable to the gateway 301. For example, the first server 500-1 may determine whether the gateway 301 is operating normally by transmitting a ping message to the gateway 301 (801) and receiving a response message thereto (803). Operations 801 and 803 may be repeatedly performed every predetermined period (e.g., every two minutes).

For example, a ping message may include any number for identifying the ping message. A ping response message may include any number included in a received ping message. The first server 500-1 may determine that a response to the corresponding ping message is received by comparing the numbers.

When the first server 500-1 repeatedly sends a ping message to the gateway 301 but there is no response, the first server 500-1 may delete the gateway 301 from the gateway list (807). For example, when the first server 500-1 transmits a ping message a predetermined number of times (e.g., three times) but no response is received, the first server 500-1 may determine that an associated program ends in the corresponding gateway 301 or that the network of the gateway 301 is disconnected.

In this case, the first server 500-1 may synchronize the gateway list with those of other servers by transmitting a gateway deletion request message to the other servers (809 and 813). The gateway deletion request message may include a synchronization index (number) of the first server 500-1. The synchronization index may be a number that is updated when the gateway list is updated (i.e., when the gateway is deleted). For example, the synchronization index may be a number that ranges from 0 to pow(2,32)−1. The gateway deletion request message may include the number of gateways registered in the first server 500-1 and the gateway list included in the first server 500-1.

For example, the gateway deletion request message may be transmitted to the second to nth servers 500-2 to 500-n included in the server list stored in the first server 500-1 (809 and 813). When the gateway deletion request message is received, the second server 500-2 may identify the first server 500-1 which has transmitted the message. For example, the second server 500-2 may identify the first server 500-1 using an IP of a source from which the message is transmitted. The second server 500-2 may load the gateway list stored in the second server 500-2. In detail, the second server 500-2 may compare a first synchronization index included in the received message and a second synchronization index stored in the second server 500-2. When the first synchronization index is greater than the second synchronization index, the second server 500-2 may update the gateway list stored in the second server 500-2 to the gateway list received through the message and may update its own second synchronization index. When the gateway update process is completed, the second server 500-2 may transmit a gateway deletion response message reflecting the processing result to the first server 500-1 (811). Operations 809 and 813 may be performed for the third to nth servers 500-3 to 500-n included in the server list of the first server 500-1 in addition to the second server 500-2.

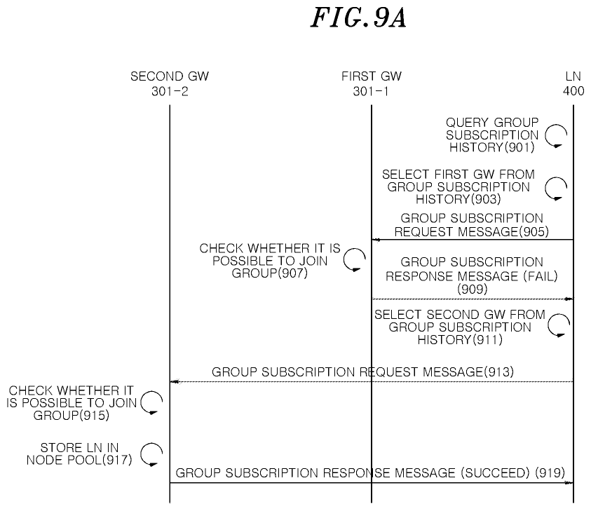

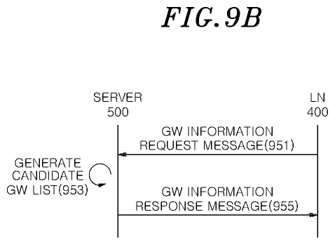

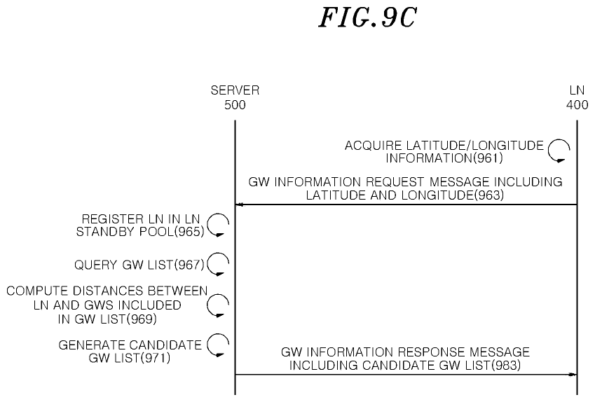

FIGS. 9A, 9B, and 9C are flowcharts illustrating an operation in which a node joins a group according to an embodiment.

A full node 300 (a full node not operating as a gateway) and a light node 400 included in a distributed network system 100 may join one group operated by at least one gateway 301. An operation of the light node 400 joining the group will be described below as an example, but the full node 300 may join the group by performing the same operation.

As an example, the light node 400 may include a group subscription history. For example, when the light node 400 has been connected to at least one gateway of the distributed network system 100, the group subscription history may include information associated with the connected gateway.

The light node 400 may query the group subscription history (901). The group subscription history may include an address of the at least one gateway. For example, the address of the gateway may be understood as an address (e.g., a public key and a wallet address) registered on the distributed network system 100. The group subscription history may include, for example, an address of a first gateway 301-1 and an address of a second gateway 301-2. The light node 400 may select the first gateway 301-1 from the group subscription history first (903) and then may transmit a group subscription request message to the first gateway 301-1 (905). The group subscription request message may include an address (e.g., a wallet address) of the light node 400. When the first gateway 301-1 receives the group subscription request message, the first gateway 301-1 may determine whether the light node 400 can join the group (907). The first gateway 301-1 may determine the received address of the light node 400 and may determine whether the light node 400 is acceptable. For example, the number of nodes acceptable for each gateway may be limited. The number may be preset according to a software policy and/or a hardware environment of each gateway.

When the light node 400 is acceptable, the first gateway 301-1 may store the address of the light node 400 in a node pool of the first gateway 301-1. The first gateway 301-1 may generate a node ID corresponding to the light node 400 and store the address of the light node 400 and the node ID in the node pool. The address of the light node 400 and the node ID may be mapped and stored.

However, when the first gateway 301-1 cannot accept the light node 400, the light node 400 should send a group subscription request to another node.

The first gateway 301-1 may transmit a group subscription response message to the light node 400 in response to the group subscription request message of the light node 400. The group subscription response message may include a success or failure response to the group subscription request. Also, when the group subscription is successful, a node ID generated for the light node 400 may be included.

For example, when the light node 400 is not acceptable, the first gateway 301-1 may transmit the group subscription response message including the failure response (e.g., null) to the light node 400 (909). The light node 400 may parse the received group subscription response message, and when a failure is determined, the light node 400 may select a gateway other than the first gateway 301-1 from the group subscription history. When there are no more other gateways in the group subscription history, the light node 400 may perform operations to be described later through FIG. 9B.

In FIG. 9A, the light node 400 may select the second gateway 301-2 included in the group subscription history (911). The light node 400 may transmit a group subscription request message to the second gateway 301-2 (913). The second gateway 301-2 may determine the received address of the light node 400 and may determine whether the light node 400 is acceptable (915). When the light node 400 is acceptable, the second gateway 301-2 may store the address of the light node 400 in a node pool of the second gateway 301-3 (917). For example, the second gateway 301-2 may generate a node ID corresponding to the light node 400 and store the address of the light node 400 and the node ID in the node pool. The second gateway 301-2 may transmit a group subscription response message to the light node 400 in response to the group subscription request message of the light node 400 (919). The corresponding group subscription response message may include a success response to a group subscription request and may include a node ID of the light node 400.

Referring to FIG. 9B, when the light node 400 does not include the group subscription history, the light node 400 may transmit a gateway information request message to a server 500 which is one of the servers included in the server list (950). The gateway information request message may include at least one of IP information of the light node 400, port information of the light node 400, latitude information of the light node 400, and longitude information of the light node 400.

The server 500 may generate a candidate gateway list in response to the gateway information request message (953). The server 500 may transmit a gateway information response message (955). The gateway information response message may include the generated candidate gateway list and information on the number of candidate gateways.

The light node 400 may perform the operations 901 to 919 above described with reference to FIG. 9A using the received candidate gateway list. If there is no currently available group, operations 951 to 955 may be repeatedly performed.

Referring to FIG. 9C, as an example, the light node 400 may acquire the latitude information and/or longitude information as location information of the light node 400 (961). For example, the light node 400 may be a portable device (e.g., a smartphone and a tablet PC). The location of the light node 400 may be changed in real time.

The light node 400 may transmit a gateway information request message including the latitude information and/or longitude information to the server 500 (963). In various embodiments, as the latitude information and/or longitude information of the light node 400 is changed, the light node 400 may request the server 500 to provide information on a gateway to be accessed. Alternatively, the light node 400 may request the server 500 to provide information on a gateway to be accessed on the basis of current location information every predetermined period.

In some embodiments, the gateway information request message may include the number of gateways requested by the light node 400, an IP address of the light node 400, latitude information of the light node 400, and longitude information of the light node 400.

The server 500 may register the light node 400 in a node standby pool (965). When the gateway information request message is received from light nodes, the server 500 may operate the node standby pool in order to sequentially process the requests. The following operations of the server 500 may be performed by the grouping module 512 of the processor 510 of the server 500.

The server 500 may query the gateway list (967) and may compute distances between the light node 400 and the gateways included in the gateway list (969). For example, the server 500 may compute a distance (e.g., a GPS coordinate distance) between the two on the basis of the latitude information and longitude information of the light node 400 and the latitude information and longitude information of the gateways. The server 500 may perform the computation on the gateways included in the gateway list and may determine candidate gateways in increasing order of distance from the light node 400. The server 500 may generate a candidate gateway list including the determined candidate gateways (971). The candidate gateway list may include a number of candidate gateways requested by the light node 400. The server 500 may transmit a gateway information response message including the candidate gateway list to the light node 400 (983).

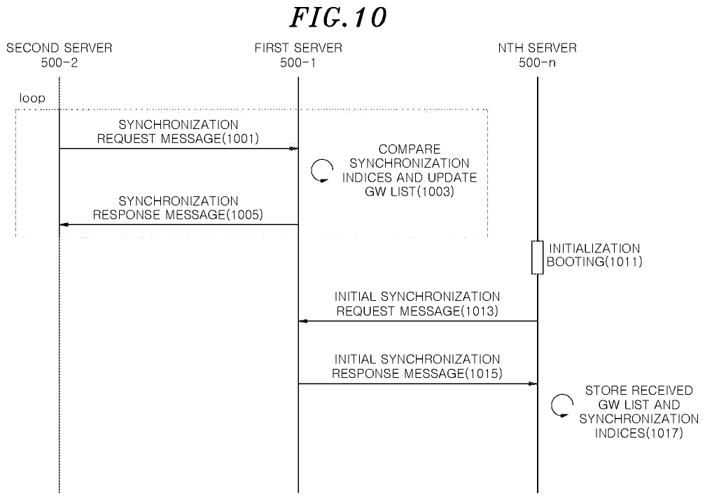

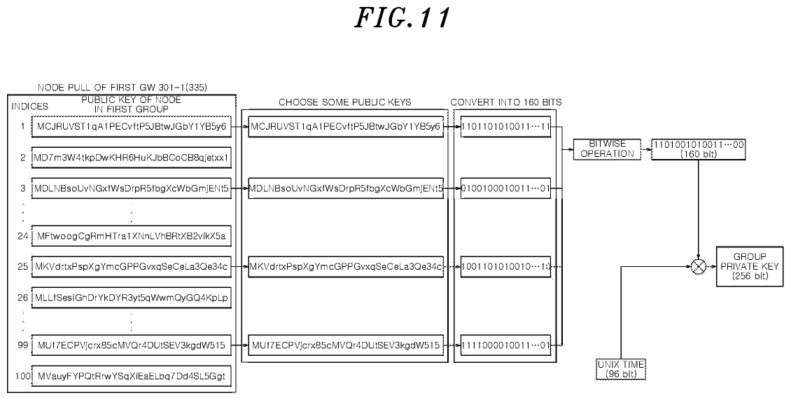

FIG. 10 is a flowchart illustrating an operation of synchronizing a gateway list between servers according to an embodiment.

The server 500 may share the gateway list included in the server 500 with other servers every predetermined period. Referring to FIG. 10, for example, the synchronization process between the first server 500-1 and the second server 500-2 is illustrated. The second server 500-2 may transmit a synchronization request message for the gateway list to the first server 500-1 (1001). The synchronization request message may include a gateway list and a synchronization index (number) which are stored in the second server 500-2. The synchronization index may be a number that is updated when the gateway list is updated. For example, the synchronization index may be a number that ranges from 0 to pow(2,32)−1.

The first server 500-1 may compare a first synchronization index included in the first server 500-1 and a second synchronization index received from the second server 500-2. When the second synchronization index is greater than the first synchronization index, the first server 500-1 may update the gateway list stored in the first server 500-1 to the gateway list received through the message and may update its own first synchronization index (1003). The first server 500-1 may transmit a synchronization request response message to the second server 500-2. The synchronization request response message may include a processing result (a success or a failure) for a synchronization request. Operations 1001 to 1005 may be performed between different servers included in the distributed network system 100 every predetermined period.

In various embodiments, the nth server 500-n which is newly added may perform initialization booting (1011) and may transmit an initial synchronization request message to the first server 500-1, which is any neighboring server (1013). The first server 500-1 may transmit an initial synchronization response message to the nth server 500-n. The initial synchronization response message may include information regarding the servers included in the distributed network system 100. Information regarding the servers may include the number of servers, a gateway list stored in the servers, the number of gateways, and a synchronization index for the gateway list. When the initial synchronization response message is received, the nth server 500-n may store information included in the message and perform synchronization.

FIG. 11 is an exemplary diagram of an operation of a gateway (a node group management device in the appended claims 301 generating a group private key according to an embodiment.

As described above, the gateway 301 may function to manage some of the nodes participating in the blockchain network as one group. A group private key generation module 316 of the gateway 301 may generate a group private key to be used for a dual signature in addition to a private key when nodes in its own group perform a transaction signature. The gateway 301 may distribute, to other groups, a group public key to be shared with the nodes in its own group and to be used for signature verification for the group private key.

Referring to FIG. 11, the gateway 301 stores information on nodes participating in its own group in the node pool 335. The node pool 335 may map and store index information for identifying each node in the group and public key information of each node. For example, when the first gateway 301 manages 100 nodes, the node pool 335 may map and store index information 1 to 100 of 100 nodes and corresponding public keys.

First, to generate a group private key, the gateway 301 may choose some of the public keys of the nodes stored in the node pool 335. As shown in FIG. 11, the gateway 301 may randomly select public keys mapped to the index information 1, 3, 25, and 99. Alternatively, the following example method may be used.

For example, the gateway 301 may choose a public key with an index corresponding to a multiple of the quotient obtained by dividing the total number of nodes in the group by a predetermined natural number. For example, when the total number of nodes is 100, the gateway 301 may choose public keys mapped to indices of 14, 28, 42, 56, 50, 84, and 98, which are multiples of 14, which is the quotient obtained by dividing 100 by 7, which is a random natural number.

Subsequently, the gateway 301 may convert each of the chosen public keys through a predetermined hash generation algorithm such that bit information composed of only bits is output. For example, a bit string composed of 160 bits may be extracted by applying base58 decoding to each public key.

Subsequently, the gateway 301 may perform a bitwise operation (e.g., ^, &, >>, <<, or a combination thereof) on each bit string to generate one composite bit string (see FIG. 11; 160 bits “1101001010011..00”).

Subsequently, the gateway 301 may generate a group private key by connecting a bit string composed of time information to the composite bit string. In this case, the time information bit string may use UNIX TIME. The gateway 301 may connect any bit string to the time information bit string so as to make the number of bits of the group private key equal to the number of bits of the private key.

For example, in order to create a group private key of 256 bits, when the composite bit string is 160 bits, 96 bits have to be connected, so the time information bit string may be composed of Current Time (32 bits)×sysrandom (64 bits). However, this is just an example, and how to generate a group private key is not limited to this example.

When one group private key is continuously used, the gateway 301 may newly generate a group private key at predetermined periods or when a change (e.g., the addition or withdrawal of a node) occurs in the group managed by the gateway 301, the gateway 301 may newly generate a group private key to distribute the generated group private key to the nodes in the group in order to prevent the group private key from being exposed by malicious attacks.

The generation period of the group private key may be selected in consideration of a communication delay (e.g., 2 to 4 seconds) of a message transmitted and received between gateways 301 because the group public key generated from the group private key has to be shared between the gateways 301. According to an embodiment, the generation period of the group private key may be 5 to 60 seconds, but these values are just examples. The present invention is not limited thereto.

The group public key generation module 316 of the gateway 301 may generate a group public key from a group private key through a predetermined function. The predetermined function, which is an irreversible function that can generate a group public key not on the basis of a first group public key but on the basis of a group private key, may include, for example, the Elliptic Curve Digital Signature Algorithm (ECDSA), but the present invention is not limited thereto.

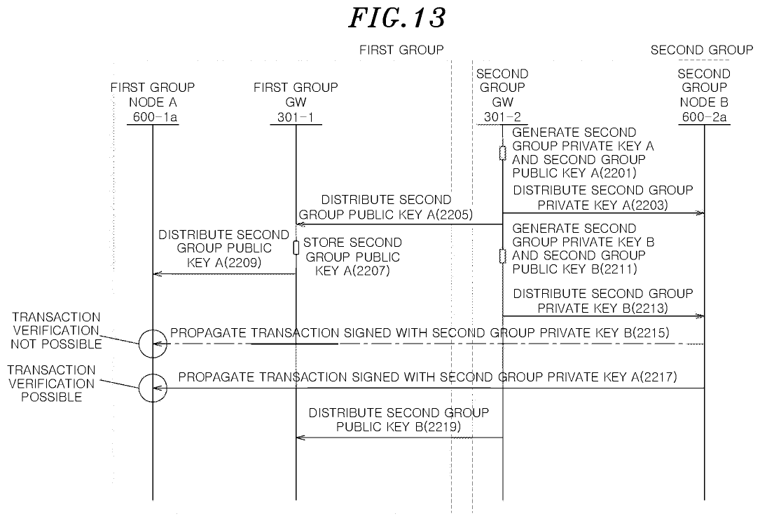

FIG. 12 is a flowchart illustrating an operation of a gateway 301 generating and distributing a group private key and a group public key according to an embodiment.

As a prerequisite operation, a method of the gateway 301 choosing a node to be included in the group or receiving a request for participation in a group from a node to determine the group may refer to the above-described operations of FIGS. 9A to 9C, but a method of the gateway 301 determining a group composed of a plurality of nodes is not limited thereto, and various methods may be used.

Hereinafter, an operation of the gateway 301 generating and distributing a group private key and a group public key will be described by referring to a gateway that manages a first group as a first group gateway 301-1, referring to a node included in the first group as a first group node 600-1, referring to a gateway that manages a second group as a second group gateway 301-2, and referring to a node included in the second group as a second group node 600-2.

The first group gateway 301-1 may generate a first group private key and a first group public key on the basis of information regarding nodes included in the first group (2001).

The first group gateway 301-1 may distribute the first group private key (or both the first group private key and the first group public key) to first group nodes (2003). A first group node “a” 600-1a, which is one of the first group nodes, may receive the first group private key and self-generate the first group public key.

The first group gateway 301-1 may distribute the first group public key to external groups (2005). The second group gateway 301-2, which manages the second group, among the external groups may receive and store the first group public key (2007). The second group gateway 301-2 may distribute the first group public key to second group nodes (2009). A first group node “a” 600-2a, which performs a transaction verification function, among the second group nodes may store and use the first group public key to verify a transaction generated by the first group.

In addition, it is assumed that a change occurs in the first group nodes after the first group private key is generated. A node “b” may transmit a group subscription request to the first group gateway 301-1 (2011). The first group gateway 301-1 may approve the group subscription request of the node “b” and store information on a first group node “b” 600-1b in the node pool 335 (2013). The group subscription operation may be performed through the operations of FIGS. 9A to 9C, but the present invention is not limited thereto.

The first group gateway 301-1 may newly generate a first group private key and a first group public key on the basis of newly changed information of the node pool 335 (2015).

The first group gateway 301-1 may distribute the first group private key (or both the first group private key and the first group public key) to first group nodes (2017). A first group node “a” 600-1a and a second group node “b” corresponding to the first group nodes may receive the first group private key and self-generate the first group public key.

The first group gateway 301-1 may distribute the first group public key to external groups (2019). The second group gateway 301-2, which manages the second group, among the external groups may receive and store the first group public key (2021). The second group gateway 301-2 may distribute the first group public key to second group nodes (2023). A first group node “a” 600-2a, which performs a transaction verification function, among the second group nodes may store and use the first group public key to verify a transaction generated by the first group. The first group gateway 301-1 may periodically generate the first group private key and the first group public key even if no change occurs in the group.

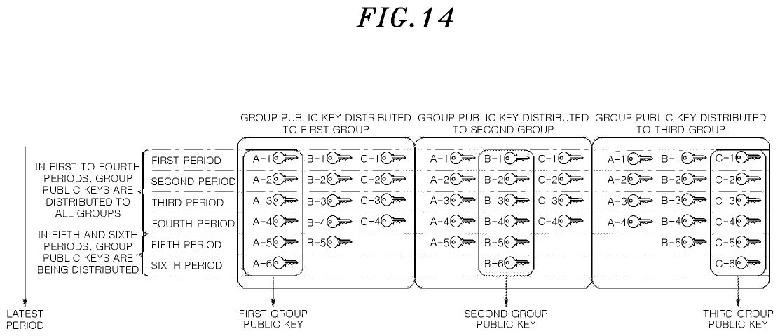

Meanwhile, a situation in which, since there is a time difference when a transaction signed with a recently generated group private key is received from an external group and when a recently generated group public key is received from the external group, the recent group public key is received later than the transaction and thus verification fails even if the transaction is correctly generated will be described with reference to FIG. 13.

FIG. 13 is a flowchart illustrating a situation in which a node can perform verification and a situation in which a node cannot perform verification depending on a selection of a group private key according to an embodiment.

First, a second group gateway 301-2 may generate a second group private key “a” and a second group public key “a” on the basis of information on nodes included in a second group (2201).

The second group gateway 301-2 may distribute the second group private key “a” (or both the second group private key “a” and the second group public key “a”) to second group nodes (2203). A first group node “a” 600-2a, which is one of the second group nodes, may receive the second group private key “a” and self-generate the second group public key “a.”

The second group gateway 301-2 may distribute the second group public key “a” to external groups (2205). The first group gateway 301-1, which manages the first group, among the external groups may receive and store the second group public key “a” (2207). The second group gateway 301-2 may distribute the second group public key “a” to first group nodes (2209).

Meanwhile, when group information is changed or the generation period has come, the second group gateway 301-2 may newly generate a second group private key “b” and a second group public key “b” on the basis of information on the nodes included in the second group (2211) and may distribute the second group private key “b” to the second group nodes (2213).

However, when a transaction signed with the second group private key “b” by the first group node “a” 600-2a reaches the first group before the second group public key “b” is distributed to the first group (2215), the transaction cannot be verified even if the transaction is correctly signed because the first group node “a” 600-1a does not store the second group private key “b.”

Therefore, when the second group public key “b” is not distributed to the first group, although the first group node “a” 600-2a has received the new second group private key “b,” a corresponding transaction may be verified only when the transaction is signed with the prestored second group private key “a.” The state of the group public key held by each group will be described in detail with reference to FIG. 14.

FIG. 14 is an example diagram showing states of group public keys distributed to groups according to an embodiment. Large boxes indicate the current states of group public keys distributed to first, second, and third groups. Also, first to sixth periods in the vertical direction each refer to a period in which a group key is generated, and as the number goes down, the group key is generated later. Also, A-1 to A-6 represent group public keys generated by a first group, B-1 to B-6 represent group public keys generated by a second group, and C-1 to C-6 represent group public keys generated by a third group.

Referring to FIG. 14, in the current state, the first group is generated up to group public key A-6, but due to a distribution delay 2219, group public key A-6 has not yet reached the second group, and group public keys A-5 and A-6 have not yet reached the third group. Therefore, even if a node in the first group signs a transaction with group private key A-6, nodes in the second group and the third group cannot verify the corresponding transaction. Also, even if a node in the first group signs a transaction with group private key A-5, nodes in the third group cannot verify the corresponding transaction. Accordingly, a delay in execution of the transaction may occur.

Therefore, in order to prevent such a situation, a node in the first group may sign a transaction with a group private key that has already been distributed to all nodes in the blockchain network even if the node has a recently distributed group private key.

To this end, a node may also receive distributed group private key time information and may store a predetermined number of group private keys in the latest order. When a transaction is generated, a node may sign the transaction with a group private key generated a predetermined period or time (e.g., which is set in consideration of a communication delay time required to distribute the group public key to all nodes of the blockchain) before the group private key is most recently stored in order to prevent a situation in which the transaction cannot be verified, as in operation 2217 of FIG. 15.

FIG. 15 is a conceptual view of a dual signature for a transaction based on a group private key and dual verification for a transaction based on a group public key according to an embodiment.

Referring to FIG. 15, a node may generate first signature information obtained by hashing the content of a message and a private key together and second signature information obtained by hashing the content of a message and a group private key together. Accordingly, the node may include the message, the first signature information, the second signature information, the public key, and the group public key as the structure of a transaction to be generated in the blockchain network. For example, a transaction distributed over the blockchain network may include a hexadecimal sequence in which the order of information is arranged according to a predetermined protocol as an actual example of 1027d774e8a4f7e03d226dcab58298fa8a0acc78afeb309d7195cb930f55dccaf2203a6960346cc0698247d4178f521e0c5e43f1b28b3b647b9413e0058f6108f6ddd. A node which has received the corresponding transaction may classify hexadecimal information in a predetermined format and pile the information on a stack. For example, when the format protocol is OP_0<Sig-Wallet><Sig-Group>OP_2<Public Key Wallet><Public Key Group>OP_2 OP_CHECKMULTISIG, the node which has received the transaction may extract the first signature information from a digit string corresponding to <Sig-Wallet>, the second signature information from a digit string corresponding to <Sig-Group>, the public key information from a digit string corresponding to <Public Key Wallet>, and group public key information from a digit string corresponding to <Public Key Group>.

Accordingly, the node that has received the transaction may verify whether a first signature is signed with the correct private key through the public key and verify that a second signature is signed with the correct group private key through the group public key to finally verify whether the corresponding transaction is correct.

According to the above-described embodiments, the private key and the group private key are used together to sign a transaction. Thus, it is possible to prevent damage due to hacking by using a configuration requesting the signature with the group private key even if the private key is hacked. Also, by generating and distributing a group private key and a group public key through a gateway 301 with secured reliability, it is possible to increase the reliability of a group key-based transaction signature. In addition, by generating a group private key periodically or whenever a change occurs in a group, it is possible to minimize the possibility of exposing the group private key. Also, by signing a transaction with a group private key distributed to all nodes in the blockchain network when a node generates the transaction, it is possible to prevent transaction verification errors due to a distribution delay.

The order of operations described with reference to FIGS. 11 to 15 is just an example, and the time-series order is not limited and may be logically changed according to design. Also, the operations of the gateway 301 that have been described with reference to FIGS. 11 to 15 may be understood as operations performed by a module included in the processor of FIG. 4. In addition, the operations of the node that have been described with reference to FIGS. 11 to 15 may be understood as operations performed by a module included in a processor of the full node of FIG. 4 or the light node of FIG. 5.

The various embodiments and the terms used herein are not intended to limit the technical features disclosed herein to specific embodiments and should be understood to include various modifications, equivalents, or alternatives of the corresponding embodiments. In describing the drawings, similar reference numerals may be used to designate similar or relevant constituent elements. The singular form of a noun corresponding to an item may include one or more of items, unless the context clearly indicates otherwise.

Herein, phrases such as “A or B,” “at least one of A and B,” “at least one of A or B,” “A, B, or C,” “at least one of A, B, and C,” and “at least one of A, B, or C” may include all possible combinations of items listed in the phrases. Terms such as “first” and “second” may simply be used to distinguish corresponding elements from the other elements, and the corresponding elements are not limited in other respects (e.g., importance or order). When a certain (e.g., first) element is referred to as being “coupled” or “connected” to another (e.g., second) element, with or without a term “functionally” or “communicatively,” it means that the certain element can be connected to the other element directly (e.g., by wire), wirelessly, or via a third element.

The term “module” used herein may include a unit implemented in hardware, software, or firmware and may be used interchangeably with, for example, terms such as logic, logic block, component, or circuit. The “module” may be an integrated component, a minimum unit for performing one or more functions, or a part thereof. For example, according to an embodiment, the “module” may be implemented in the form of an application-specific integrated circuit (ASIC).

Various embodiments disclosed herein may be implemented by software (e.g., a program) including one or more instructions stored in a storage medium (e.g., a memory) readable by a machine (e.g., an electronic device). For example, the storage medium may include a random access memory (RAM), a memory buffer, a hard drive, a database, an erasable programmable read-only memory (EPROM), an electrically erasable read-only memory (EEPROM), a read-only memory (ROM), and the like.

Also, the processor of the embodiments of the present disclosure may fetch and execute at least one of the instructions stored in the storage medium. This allows the machine to be operated to perform at least one function in accordance with the fetched instruction. The one or more instructions may include code generated by a compiler or code executable by an interpreter. The processor may be a general-purpose processor, a field-programmable gate array (FPGA), an application-specific integrated circuit (ASIC), a digital signal processor (DSP), and the like.

The machine-readable storage medium may be provided in the form of a non-transitory storage medium. Here, the term “non-transitory” merely denotes that the storage medium is tangible and does not include a signal (e.g., electromagnetic waves), irrespective of whether data is semi-permanently or temporarily stored in the storage medium.

The methods according to various embodiments disclosed herein may be included and provided in a computer program product. The computer program product may be traded between a seller and a purchaser as a commodity. The computer program product may be distributed in the form of a machine-readable storage medium (e.g., compact disc read-only memory (CD-ROM)), or may be distributed (e.g., downloaded or uploaded) via an application store (e.g., PlayStore™), directly between two user devices (e.g., smartphones), or online. For online distribution, at least a portion of the computer program product may be at least provisionally generated or temporarily stored in a machine-readable storage medium such as a memory of a manufacturer's server, an application store's server, or a relay server.

According to various embodiments, each of the above-described elements (e.g., modules or programs) may include one or more entities. According to various embodiments, one or more of the above-described elements or operations may be omitted, or one or more other elements or operations may be added. Alternatively or additionally, a plurality of elements (e.g., modules or programs) may be integrated into one element. In such a case, the integrated element may perform one or more functions of each of the plurality of elements in the same or a similar manner as performed by the corresponding one among the plurality of elements prior to the integration. According to various embodiments, operations performed by a module, a program, or other elements may be executed sequentially, in parallel, repeatedly, or heuristically. One or more of the operations may be omitted or executed in different orders. Alternatively, one or more other operations may be added.

1. A node group management device that manages a first group to which some nodes belong among nodes that constitute a blockchain network sharing a distributed database, wherein all nodes participating in the blockchain network each include a private key and a public key, the node group management device comprising:
a communication interface configured to communicate with the blockchain network;
one or more memories configured to store information related to a node of the first group and instructions related to processor operations, wherein the information related to the node of the first group includes a public key of each node of the first group; and
one or more processors connected to the one or more memories to operate according to the instructions and configured to generate a group private key that allows a transaction to be additionally signed based on the information related to the node of the first group while the transaction is signed with the private key when the node of the first group generates the transaction and configured to distribute the group private key to the first group so that the nodes of the first group hold the group private key in common.

2. The node group management device of claim 1, wherein the one or more processors generate the group private key on the basis of time information and the public keys of some of the nodes of the first group.

3. The node group management device of claim 2, wherein the one or more processors convert the public keys of some of the nodes into bit sequences on the basis of a predetermined hash generation algorithm, convert the bit sequences into one composite bit sequence by performing a predetermined bitwise operation, configure the time information as a bit sequence, and connect the bit sequence of the time information to the composite bit sequence to generate the group private key such that the group private key has the same number of bits as the private key.

4. The node group management device of claim 3, wherein the one or more processors newly generate the group private key on the basis of new time information every predetermined period and distribute the generated group private key to the first group, and
the predetermined periods are longer than a communication delay time in which all data is distributed over the blockchain network.

5. The node group management device of claim 3, wherein when a change occurs in the first group, the one or more processors newly generate the group private key on the basis of information related to the public keys of some nodes of the first group in which the change occurs and distribute the generated group private key to the group.

6. The node group management device of claim 1, wherein
the one or more processors newly generate the group private key every predetermined period and distribute the generated group private key to the nodes of the first group, and
the nodes of the first group store a plurality of group private keys along with information on a time at which the distributed group private key is received and sign the transaction with a group private key generated a predetermined period before the current period among the plurality of group private keys when generating the transaction.

7. The node group management device of claim 6, wherein the transaction includes a message, a first signature signed on the message with the private key, a public key corresponding to the private key, a second signature signed on the message with the group private key, and a group public key corresponding to the group private key.

8. The node group management device of claim 6, wherein
the one or more processors generate a group public key corresponding to the group private key generated every predetermined period and distribute the group public key to a second group, which is another group of the blockchain network, and
a node of the second group stores a plurality of group public keys along with information on a time at which the distributed group public key is received and verifies a transaction generated by a node of the first group using all of the plurality of group public keys when the transaction generated by the node of the first group is verified.

9. A computing device that performs nodes constituting a blockchain network sharing a distributed database, wherein all nodes participating in the blockchain network each include a private key and a public key, the computing device comprising:
a communication interface configured to communicate with the blockchain network;
one or more memories configured to store information related to a node group device of claim 1 that manages a first group to which one of the nodes belongs, a plurality of group private keys distributed by the node group device over time, and instructions related to processor operations, wherein the plurality of group private keys include time information; and
one or more processors connected to the one or more memories to operate according to the instructions and configured to add, to a transaction, a signature with a group private key generated a predetermined period before a group private key is most recently stored among the plurality of group private keys with reference to the time information when the transaction is generated.

10. A node group management method performed by a node group management device and nodes that constitute a blockchain network sharing a distributed database, wherein all the nodes of the blockchain network each hold a private key and a public key, the node group management method comprising:
receiving, by the node group management device, information related to a node of a first group from the node of the first group, wherein the first group is a group including nodes managed by the device, and the information related to the node of the first group includes a public key of the node of the first group;
generating, by the node group management device, a group private key used to additionally sign a transaction along with the private key on the basis of the information related to the node of the first group when the node of the first group generates the transaction; and
distributing, by the node group management device, the group private key to the nodes of the first group so that the nodes of the first group hold the group private key in common.

11. The node group management method of claim 10, wherein the generating of the group private key comprises: converting the public keys of some of the nodes into bit sequences on the basis of a predetermined hash generation algorithm, converting the bit sequences into one composite bit sequence by performing a predetermined bitwise operation, configuring the time information as a bit sequence, and connecting the bit sequence to the composite bit sequence to generate the group private key such that the group private key has the same number of bits as the private key.

12. The node group management method of claim 10, wherein
the distributing comprises newly generating the group private key every predetermined period and distributing the generated group private key to the nodes of the first group, by the node group management device, and
the node group management method further comprises storing a plurality of group private keys along with information on a time at which the distributed group private key is received and signing the transaction with a group private key generated a predetermined period before the current period among the plurality of group private keys when generating the transaction, by the node of the first group.

13. The node group management method of claim 12, wherein
the distributing comprises generating a group public key corresponding to the group private key generated every predetermined period and distributing the group public key to a second group, which is another group of the blockchain network, and
the node group management method further comprises:
storing, by a node of the second node, a plurality of group public keys along with information on a time at which the distributed group public key is received; and
verifying, by the node of the second node, a transaction generated by a node of the first group using all of the plurality of group public keys when the transaction generated by the node of the first group is verified.

14. A computer-readable recording medium having a computer program recorded thereon that includes an instruction for causing a processor to execute the method of claim 10.

15. A computer program stored in a computer-readable recording medium to cause a processor to perform the method of claim 10.
